(19) United States
(12) Patent Application Publication
(10) Pub. No.: US 2026/0233526 A1
(43) Pub. Date: Aug. 13, 2026

(54) METHOD AND APPARATUS FOR JET HEALTH PRESERVATION IN CUT SHEET AQUEOUS INKJET SYSTEMS

(71) Applicant: Xerox Corporation, Norwalk, CT (US)

(72) Inventors: Seemit Praharaj, Marlborough, NH (US); Douglas K. Herrmann, Webster, NY (US); Jason M. LeFevre, Penfield, NY (US); Anthony S. Condello, Webster, NY (US); Varun Sambhy, Pittsford, NY (US); Peter M. Gulvin, Webster, NY (US); Mark C. Petropoulos, Webster, NY (US); Christine A. Steurrys, Williamson, NY (US); Nicholas David Stucchi, Greece, NY (US)

(73) Assignee: Xerox Corporation, Norwalk, CT (US)

(21) Appl. No.: 19/051,763

(22) Filed: Feb. 12, 2025

(51) Int. Cl. B41J 2/165

(52) U.S. Cl. CPC B41J 2/16507; B41J 2/16508

(57) ABSTRACT

Provided herein are inkjet printing systems and methods for preserving inkjet health in such inkjet printing systems. The systems and methods described herein may be applied to a number of different types of printing arrangements, but may find particular application in connection with cut-sheet inkjet printing systems where there is continuous narrow-media printing. According to various embodiments, the printing systems comprise one or more printheads and a retractable printhead shield configured to selectively cover unused portions of the printheads.

### FIELD OF THE DISCLOSURE

The present disclosure relates generally to inkjet printing systems, and more specifically to systems and methods for preserving inkjet health in such inkjet printing systems.

### BACKGROUND

Inkjet printheads, like piezoelectric printheads, are crucial components of inkjet printing systems and are responsible for transferring ink onto a print media substrate to create text and/or images. These printheads work by ejecting tiny droplets (e.g., on the order of several to tens of picoliters, a picoliter being one trillionth of a liter) through microscopic nozzles, which are arranged in a precise array. Each nozzle is connected to an ink chamber that holds the ink before ejection. A set of actuators are responsible for creating the pressure pulse that forces the ink out of the nozzles. Piezoelectric actuators are common and employ piezoelectric crystals that change shape when an electric charge is applied, thereby creating a pressure pulse.

In operation, an electric charge is applied to the piezoelectric crystal, causing it to flex and create a pressure pulse. This pulse jets a droplet of ink out of the nozzle. When the charge is removed, the crystal returns to its original shape, drawing more ink into the chamber. The printhead is controlled by electronic circuits that manage the timing and sequence of droplet jetting to ensure accurate printing.

A single inkjet printing system may contain one or more distinct printheads, and each printhead may contain hundreds or thousands of individual inkjet nozzles arranged in a compact printing array (e.g., within less than a 2 inch by 6 inch area). One or more printheads may be stationary while the print media moves below them, or may move across the print media substrate to deposit ink at specific locations and form the desired print.

While advancements in inkjet printhead technologies have enabled significantly improved image generation and faster printing speeds, there are a number of drawbacks to these printing systems. For example, aqueous inks formulated for piezoelectric inkjet applications typically comprise a significant amount of water (e.g., 50-65%), which makes these inks highly susceptible to drying out. At the nozzle level inside a piezoelectric inkjet printhead, this drying out can result in the formation of viscous plugs, cause intermittent, weak, misdirected, and/or missing jets resulting in runtime image quality issues, pigment agglomeration/falling out from suspension due to unstable ink formulation, as well as permanent changes in the aperture surface characteristics due to continuous contamination.

### SUMMARY OF THE DISCLOSURE

As described herein, it is appreciated that it would be advantageous to provide systems and methods for preserving inkjet health by preventing drying out of printhead nozzles. Embodiments of the present disclosure improve upon these and other aspects in the technology.

According to an embodiment of the present disclosure, an inkjet printing system is provided. The inkjet printing system can include: (1) a media transport system configured to move a print media substrate through a printing zone of the printing system in a process direction; (2) a printhead mounting plate spaced vertically apart from the media transport system, wherein the printhead mounting plate comprises (i) a first surface, (ii) a second surface, and (iii) one or more frames configured to receive one or more printheads at the first surface, respectively, wherein the second surface is vertically adjacent to the media transport system; (3) a retractable printhead shield disposed between the second surface of the printhead mounting plate and the media transport system, wherein the retractable printhead shield has a width that is greater than or equal to a width of the one or more frames; and (4) a linear actuator coupled to the retractable printhead shield and configured to slide the retractable printhead shield under the one or more frames in a direction perpendicular to the process direction.

In an aspect, the inkjet printing system can further include a controller operatively connected to the linear actuator, wherein the controller is configured to adjust a position of the retractable printhead shield, via the linear actuator, such that a portion of at least one frame of the one or more frames is covered.

In an aspect, the position of the retractable printhead shield can be adjusted based on a width of the print media substrate moving through the printing zone.

In an aspect, the controller can be configured to (i) determine an unused portion of the one or more printheads received by the one or more frames, and (ii) adjust the position of the retractable printhead shield to cover the unused portion of the one or more printheads.

In an aspect, the retractable printhead shield can include a first absorbent layer disposed on a frame-facing surface of the retractable printhead shield, the first absorbent layer being configured to absorb an amount of ink ejected by the one or more printheads.

In an aspect, the first absorbent layer can be configured to be replaceable by at least a second absorbent layer.

In an aspect, the retractable printhead shield and linear actuator can be mounted onto the printhead mounted plate.

In an aspect, the width of the retractable printhead shield can be approximately equal to a width of the printhead mounting plate.

In an aspect, the retractable printhead shield can have a length that is greater than or equal to a length of the one or more frames.

In an aspect, the second surface of the printhead mounting plate can be spaced less than 5 mm vertically apart from the media transport system, and wherein the retractable printhead shield is a thin planar sheet having a thickness of less than 1 mm.

According to another embodiment of the present disclosure, a print bar assembly is provided. The print bar assembly can include: (1) a printhead mounting plate comprising (i) a first surface, (ii) a second surface, and (iii) one or more frames configured to receive one or more printheads at the first surface, respectively; (2) a retractable printhead shield disposed vertically adjacent to the second surface of the printhead mounting plate, wherein the retractable printhead shield has a width that is greater than or equal to a width of the one or more frames; and (3) a linear actuator coupled to the retractable printhead shield and configured to slide the retractable printhead shield under the one or more frames in a direction perpendicular to a process direction.

In an aspect, the retractable printhead shield can include a first absorbent layer disposed on a frame-facing surface of the retractable printhead shield, the first absorbent layer being configured to absorb an amount of ink ejected by the one or more printheads.

In an aspect, the first absorbent layer can be configured to be replaceable by at least a second absorbent layer.

In an aspect, the retractable printhead shield and linear actuator can be mounted onto the printhead mounted plate.

In an aspect, the width of the retractable printhead shield can be approximately equal to a width of the printhead mounting plate.

In an aspect, the retractable printhead shield can have a length that is greater than or equal to a length of the one or more frames.

In an aspect, the retractable printhead shield can be a thin planar sheet having a thickness of less than 1 mm.

According to yet another embodiment of the present disclosure, a method for preserving inkjet health in an inkjet printing system is provided. The method can include: (1) receiving, by the inkjet printing system, a print job to be completed by the inkjet printing system, wherein the print job comprises print job attributes including at least a print media substrate width; (2) determining, by the inkjet printing system, an unused portion of one or more printheads of the inkjet printing system based on the print media substrate width; and (3) adjusting, via a linear actuator of the inkjet printing system, a position of a retractable printhead shield such that the retractable printhead shield covers the unused portion of the one or more printheads.

In an aspect, the method can further include: (4) rendering an image on the print media substrate based on the print job received.

In an aspect, the method can further include: (5) determining, by the inkjet printing system, a plurality of unused inkjets corresponding to the unused portion of the one or more printheads; and (6) ejecting, by the inkjet printing system, one or more ink droplets from the plurality of unused inkjets onto an absorbent layer of the retractable printhead shield while rendering the image on the print media substrate.

These and other aspects of the various embodiments will be apparent from and elucidated with reference to the embodiments described hereinafter.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the various embodiments.

FIG. 1 is a block diagram of a production inkjet printing system shown in accordance with aspects of the present disclosure.

FIG. 2 is top-down illustration of an image forming device and associated media transport system used to form images on print media according to aspects of the present disclosure.

FIG. 3 is a lower perspective view of a print bar assembly having a retractable printhead shield illustrated in accordance with aspects of the present disclosure.

FIG. 4 is a top perspective view of a print bar assembly having a retractable printhead shield illustrated in accordance with aspects of the present disclosure.

FIG. 5A is a perspective view of a retractable printhead shield illustrated in accordance with aspects of the present disclosure.

FIG. 5B is a front plan view of a retractable printhead shield illustrated in accordance with aspects of the present disclosure.

FIG. 6A is a front plan view of a retractable printhead shield having an absorbent member illustrated in accordance with aspects of the present disclosure.

FIG. 6B is a diagram of an absorbent member illustrated in accordance with aspects of the present disclosure.

FIG. 6C is a diagram of an absorbent member illustrated in accordance with further aspects of the present disclosure.

FIG. 7 is a flowchart illustrating a method of preserving inkjet health in accordance with aspects of the present disclosure.

FIG. 8 is a block diagram illustrating a printer controller in accordance with aspects of the present disclosure.

### DETAILED DESCRIPTION OF EMBODIMENTS

The present disclosure relates generally to inkjet printing systems, and more specifically to systems and methods for preserving inkjet health in such inkjet printing systems. In particular, it will be appreciated that aqueous inks formulated for piezoelectric inkjet applications typically comprise of 50-65% water. The large water content makes these inks highly susceptible to drying. At the nozzle level inside a printhead, drying of inks (i.e., reduction in water content) can have consequences ranging from mild to catastrophic. For example, in mild cases, viscous plugs may be formed in the nozzle, which may be cleared via a timely application of a pressure pulse to eject a nominal ink mass from the nozzles (a process known as purging). In moderate cases, intermittent, weak, misdirected, split, and/or missing jets can develop, resulting in runtime image quality defects. Resolubilization of dried ink during a purging operation may be able to provide some mitigation. In severe cases, pigment agglomeration/falling out from suspension due to unstable ink formulation can occur resulting in a temporary change in the aperture surface characteristics impacting drop directionality and consequently image quality. In catastrophic cases, permanent changes in the aperture surface characteristics may occur due to continuous contamination over long periods of time resulting in necessary printhead replacement.

The systems and methods described herein address these and other drawbacks, and may be applied to a number of different types of printing arrangements, but may find particular application in connection with cut-sheet inkjet printing systems where there is continuous narrow-media printing. In continuous narrow-media printing, a number of inkjets on the inboard printheads are exposed to chaotic airflow from the vacuum transport system, which, coupled with no drop ejection significantly deteriorates jet health in the exposed inkjets. For certain ink formulations, optimal performance of these inkjets cannot be recovered via conventional means of purging per the few scenarios described above.

Accordingly, the systems and methods of the present disclosure include a retractable printhead shield configured to preserve the health of these non-printing jets.

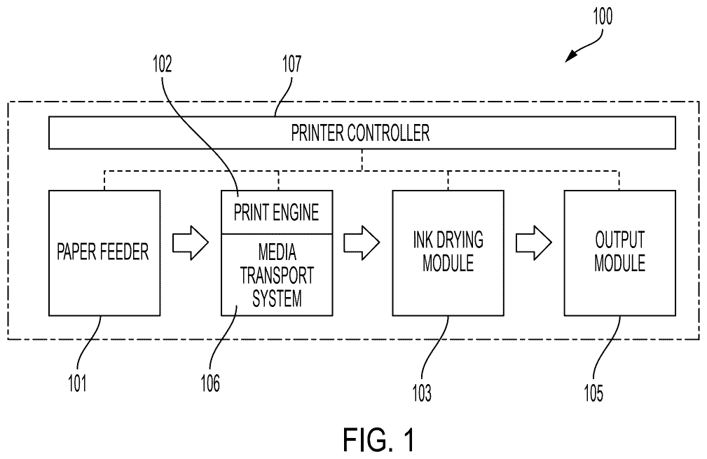

Turning to FIG. 1, a generalized block diagram of a printing system 100 is shown according to aspects of the present disclosure. In embodiments, the inkjet printing system 100 may be a digital printing press, such as a high-performance, cut-sheet inkjet printing system. The printing system 100 may also be a high-volume and high-quality inkjet printing system. In particular embodiments, the printing system 100 may be referred to as a production inkjet (PIJ) system For example and without limitation, the printing system 100 may be a Xerox Baltoro™ HF Inkjet Press, or a similar printing system.

As shown in the example of FIG. 1, the printing system 100 generally includes a cut-sheet paper feeder module 101, a print engine 102, an ink drying module 103, an output module 105, a media transport system 106, and a printer controller 107.

The paper feeder module 101 is configured to store various types of print media and convey the print media to the print engine 102 via the media transport system 106. In embodiments, the paper feeder module 101 can include one or more cassettes or trays and adjustable leveling assemblies configured to move the sheets of print media into proper position when needed for a particular print job. In embodiments, the print media can include, but is not limited to, uncoated plain paper, inkjet treated or inkjet coated paper, offset coated paper, as well as uncoated and/or un-primed paper. In further embodiments, the print media can have different sizes. For example, the feeder module 101 may allow for a maximum media width of approximately 14 inches (inboard-to-outboard direction). However, some print jobs will require media that is less than the full 14 inches wide (e.g., 12 inches for a 12″18″ media is a common size in the print industry). In this narrow media printing scenario, the paper in the printing system 100 is generally outboard registered (i.e., aligned with the outboard edge of the media transport system 106).

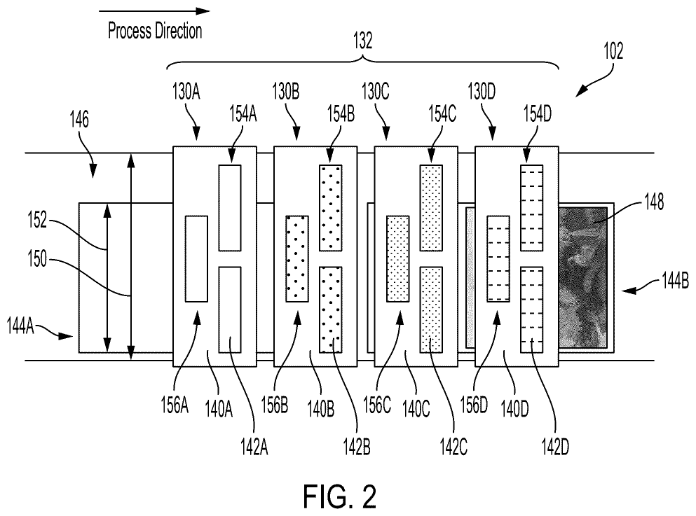

The print engine 102 is configured to eject ink droplets from one or more inkjet printheads (e.g., printheads 142A-D, 154A-D, 156A-D shown in FIG. 2) on the print media (e.g., print media 144A, 144B shown in FIG. 2) as it passes through a printing zone 132 via the media transport system 106. In embodiments, the print engine 102 comprises one or more print bar assemblies 130A-D, each print bar assembly 130A-D comprising a printhead mounting plate and one or more inkjet printheads 142A-D, 154A-D, 156A-D mounted thereon. The one or more inkjet printheads 142A-D, 154A-D, 156A-D can be operatively connected to one or more ink reservoirs. In embodiments, the ink reservoirs may be replaceable and/or refillable. Each printhead 142A-D, 154A-D, 156A-D of the print engine 102 can include a plurality of individual inkjets that can be individually controlled in order to recreate the desired image content of a print job.

In particular embodiments, each print bar assembly 130A-D may comprise one or more printheads 142A-D, 154A-D, 156A-D configured to eject ink droplets of a particular color (e.g., magenta, cyan, yellow, and black) within the printing zone. In specific embodiments, the print engine 102 can include four print bar assemblies 130A-D, each having three separate inkjet printheads 142A-D, 154A-D, 156A-D for a total of 12 printheads. In further embodiments, the inkjet printheads 142A-D, 154A-D, 156A-D may be piezoelectric printheads having hundreds or thousands of individually-addressable piezoelectric inkjets.

The ink drying module 103 is configured to apply heat and/or pressure to the print media to dry the jetted ink and fuse the jetted ink onto the print media. In embodiments, the ink drying module 103 may be referred to as a fuser. The ink drying module 103 can include one or more drying lamps that are used to dry the ink in a “non-contact” manner.

The output module 105 is configured to present the finished print media for retrieval. In embodiments, the output module 105 can include a stacker that stacks the finished print media.

Optionally, the printing system 100 can also include a finishing module (not shown) that is configured to apply various finishing details to a print job. In embodiments, these finishing details can include, for example, stappling, hole punching, binding, lamination, and/or the like, including combinations thereof.

The media transport system 106 generally includes one or more components configured to convey print media from one or more sources to the print engine 102 and then to an output module 105. In embodiments, the media transport system 106 can include a perforated transport belt 146 disposed on multiple rollers, a vacuum plenum disposed below the transport belt 146, and a vacuum source configured to apply a vacuum through the vacuum plenum and the perforated transport belt 146 in order to keep print media secured to the transport belt 146.

As mentioned above, the print engine 102 of the printing system 100 may comprise one or more print bar assemblies, and each print bar assembly may comprise one or more printheads configured to eject ink droplets of a particular color (e.g., magenta, cyan, yellow, and black) within a print zone. For example, as shown in FIG. 2, the print engine 102 includes four print bar assemblies 130A, 130B, 130C, 130D, wherein each print bar assembly 130A, 130B, 130C, 130D comprises a printhead mounting plate 140A, 140B, 140C, 140D upon which are mounted a total of 12 printheads 142A-D, 154A-D, 156A-D (i.e., three each). Each printhead 142A-D, 154A-D, 156A-D may include hundreds to thousands of individually-addressable inkjets, which may be piezoelectric inkjets that can be individually actuated.

As a print media 144A, 144B moves in a process direction through a printing zone 132 defined by the print bar assemblies 130A, 130B, 130C, 130D, the printheads 142A-D, 154A-D, 156A-D are operated to eject ink droplets in a controlled manner to generate an image on the print media 144A, 144B, like image 148 on print media 144B.

In embodiments, the printing system 100 and the printer controller 107 may be used to implement a printing path schedule based on one or more print orders. The printing system 100 may be capable of continuous printing as well as simplex and/or duplex output. As mentioned above, in cases of narrow-media printing, the width 152 of the print media 144A, 144B (and/or the width of the images 148 formed thereon) are consistently less than the full printing width 150 of the printing system 100. In such cases, there are printheads 154A, 154B, 154C, 154D that will consistently have inkjets that go unused for periods of time and therefore are susceptible to drying out. In particular embodiments, it may be possible that the printing width 152 is so small that additional printheads (e.g., printheads 156A, 156B, 156C, 156D) or portions thereof may go unused.

To address these issues, the printing systems 100 and methods of the present disclosure include a retractable printhead shield that cover (and thereby protect) the inactive parts of at least the inboard printheads 154A, 154B, 154C, 154D from turbulent airflow due to the vacuum source, which is known to cause disruption to its functionality. In embodiments, the printhead shield automatically adjusts its position during a printing operation in accordance with the sheet size as provided by an input from the customer (or from other sources, such as the attributes of the print job being completed). Additionally, as described in more detail below, the printhead shield may incorporate a replaceable absorbent adhesive layer on the surface of the cover facing the printhead. This absorbent layer can capture droplets ejected from the nozzles that aren't currently in use for printing on media. Furthermore, this absorbent layer can be replaced at regular intervals during a maintenance intervention by a technician. Accordingly, by combining continuous droplet ejection with isolation from turbulent airflow, the systems and methods of the present disclosure effectively safeguard against degradation in the printhead's performance and creates a semi-closed heavily humidified micro-environment that effectively prevents any drying in the relevant nozzles.

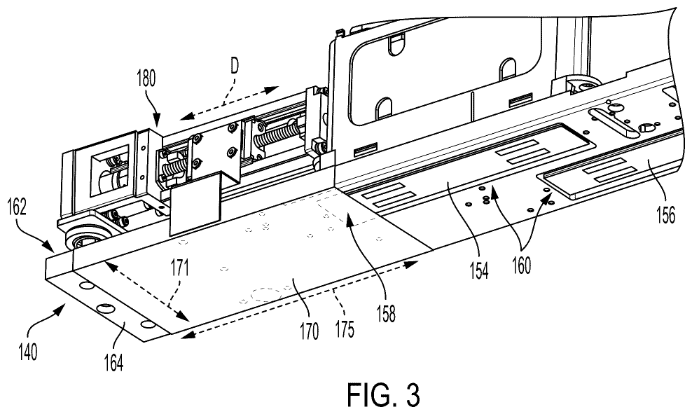

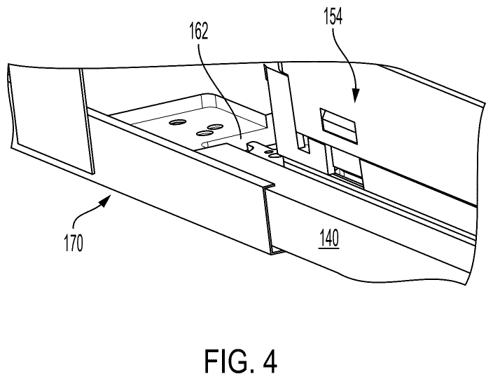

With reference to FIG. 3 and FIG. 4, a single print bar assembly 130 having a mounting plate 140 and a retractable printhead shield 170 is illustrated from different perspectives in accordance with various aspects of the present disclosure. Although only one print bar assembly 130 is shown, it should be appreciated that multiple similar print bar assemblies 130 may be included in a printing system 100, such as print bar assemblies 130A-D.

As shown, the printhead mounting plate 140 can comprise one or more open frames 160 configured to receive a respective printhead (e.g., printheads 142, 154, 156). In embodiments, each printhead 142, 154, 156 may be mounted on the plate 140 at a first surface 162 and extend through at least a portion of the plate 140. In embodiments, the mounting plate 140 has a second surface 164 that is opposite the first surface 162 and is vertically adjacent to the media transport system or a portion thereof (e.g., transport belt 146). In embodiments, the printheads 142, 154, 156 do not extend all the way to the second surface 164, i.e., the printheads 142, 154, 156 sit within the frames 160 and slightly above the second surface 164.

Also mounted to the mounting plate 140 can be a linear actuator 180 that is coupled to the retractable printhead shield 170. The linear actuator 180 can be configured to slide the retractable printhead shield 170 in a direction D under the mounting plate 140 in order to cover one or more printheads 142, 154, 156 and/or portions thereof. In embodiments, the direction D may be perpendicular to a process direction (i.e., the printing direction). As shown in FIG. 3, the retractable printhead shield 170 may cover a portion 158 of the printhead 154 and the covered portion 158 may be automatically adjusted (via the linear actuator 180) during a printing operation in accordance with the sheet size or a printing width 152.

In embodiments, the retractable printhead shield 170 may have a width 171 such that the shield 170 can cover the entire width of at least the most inboard printheads 154 (i.e., less than the full width of the printhead mounting plate 140). In particular embodiments, the printhead shield 170 may have a width 171 that is roughly equal or slightly larger than the width of the printhead mounting plate 140.

In further embodiments, the printhead shield 170 may have a length 175 such that at least a portion 158 of the most inboard printhead 154 is selectively covered or coverable. In particular embodiments, the printhead shield 170 may have a length 175 that is roughly equal to the length of a single printhead 154. In still further embodiments, the printhead shield 170 may have a length 175 greater than the length of a single printhead 154 such that the printhead shield 170 can cover the entire inboard printhead 154 and at least a portion of a second printhead 156.

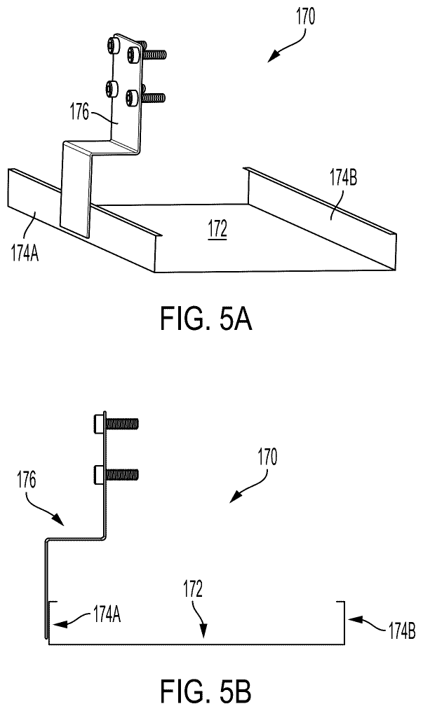

With reference to FIGS. 5A and 5B, the retractable printhead shield 170 comprises at least a thin planar portion 172 that is disposed adjacent to the second surface 164 of the printhead mounting plate 140. This planar portion 172 may have a thickness of several millimeters or less, including less than about 1 millimeter. In embodiments, the retractable printhead shield 170 may also have sidewalls 174A, 174B, which can have folded portions that cover part of the first surface 162 of the printhead mounting plate 140. As shown in FIGS. 5A and 5B, the retractable printhead shield 170 also includes a connecting arm 176 that connects the retractable printhead shield 170 to the linear actuator 180. In embodiments, the connecting arm 176 may be fastened to the linear actuator 180 by one or more screws, or coupled to the linear actuator 180 by other means.

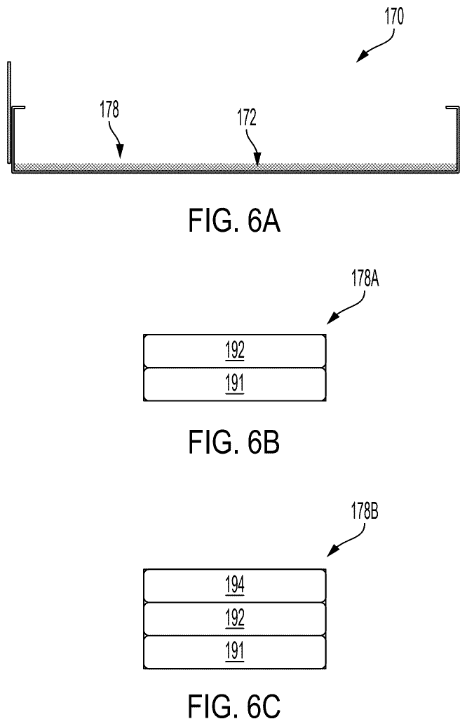

According to certain aspects of the present disclosure, the retractable printhead shield 170 may include an absorbent layer disposed thereon. For example, as shown in FIG. 6A, the retractable printhead shield 170 further comprises an absorbent layer 178 disposed on the planar portion 172 of the retractable printhead shield 170. The absorbent layer 178 is preferably disposed on at least a portion of the surface of the planar portion 172 that faces the printhead mounting plate 140.

In embodiments, the absorbent layer 178 can be configured to absorb a certain amount of accumulated ink, which may be ejected from the unused inkjets as discussed in more detail below. In particular embodiments, the absorbent layer 178 is replaceable, i.e., a user may remove one absorbent layer 178 after it has been used for a certain period of time and replace it with a new, unused absorbent layer 178. In embodiments, each absorbent layer 178 may be capable of absorbing between 5 times and 200 times its weight in accumulated ink.

With reference to FIGS. 6B and 6C, a first embodiment of an absorbent layer 178A and a second embodiment of an absorbent layer 178B are illustrated in accordance with aspects of the present disclosure. As shown in FIG. 6B, the absorbent layer 178A can comprise an absorbent material 192 coupled to an adhesive layer 191. As shown in FIG. 6C, the absorbent layer 178B can comprise an absorbent material 192 coupled to a removable liner 194 on one side and an adhesive layer 191 on an opposing side.

In embodiments, the absorbent material 192 of the absorbent layer 178A, 178B can be a lint free wiping cloth, an absorbent polymer such as polyacrylic acid sodium salts, and/or the like. The adhesive layer 191 and the removable liner 194 may formed from any suitable material known in the art.

As described above, provided are inkjet printing systems 100 and print bar assemblies 130A-D having a retractable printhead shield 170 configured to preserve the health of unused inkjets. Also provided herein are methods for preserving inkjet health in such systems.

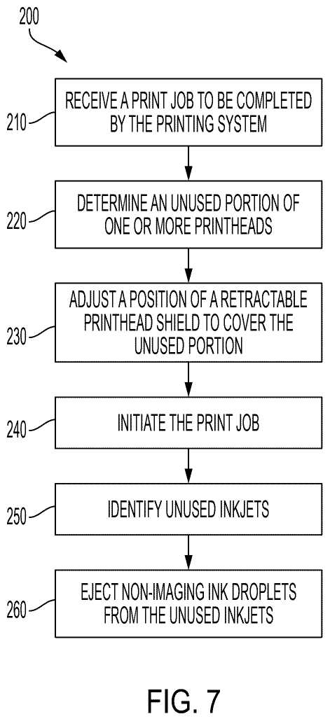

With reference to FIG. 7, a method 200 for preserving inkjet health in an inkjet printing system is illustrated in accordance with aspects of the present disclosure. The method 200 can include: in a step 210, receiving a print job to be completed by the inkjet printing system; in a step 220, determining an unused portion of one or more printheads of the inkjet printing system; and in a step 230, adjusting a position of a retractable printhead shield in order to cover the unused portion of the one or more printheads. In further embodiments, the method 200 can also include: in a step 240, beginning the print job; in a step 250, determining one or more unused inkjets corresponding to the unused portions of the printheads; and in a step 260, ejecting one or more non-imaging ink droplets from one or more unused inkjets.

More specifically, in the step 210, the method 200 can include receiving a print job to be completed by an inkjet printing system (e.g., printing system 100), wherein the print job includes one or multiple print job attributes. These print job attributes can include data necessary for forming the desired image on the print media. In particular embodiments, the print job attributes includes at least the specifications of the print media to be utilized, such as the width of the print media (e.g., width 152 shown in FIG. 2).

Next, in the step 220, a controller (i.e., the printer controller 107) of the printing system 100 can determine an unused portion of one or more printheads 142A-D, 154A-D, 156A-D based on the print job attributes, including but not limited to the width 152 of the print media to be used. As mentioned above with respect to FIG. 2, it should be appreciated that in narrow-media printing scenarios, at least a portion of the inboard printheads 154A-D will not be used. When performing continuous or large-scale print jobs, the inkjets corresponding to these portions of the printheads 154A-D will go unused for an undesirable amount of time.

Thus, in the step 230, the controller 107 of the printing system 100 will adjusting the position of a retractable printhead shield 170 using a linear actuator 180 so that the retractable printhead shield 170 covers the unused portions (e.g., portions 158) of the one or more printheads 154A-D.

In the next step 240, the controller 107 of the printing system 100 will begin the scheduled print job while the unused portions 158 of the printheads 154A-D are covered by the retractable printhead shield 170. Thus, it should be understood that the retractable printhead shield 170 will therefore cover the inkjets not being used to form the desired image(s) during the scheduled print job.

In particular embodiments, the method 200 may also include selectively actuating the unused inkjets while the scheduled print job is being completed. That is, in order to further prevent drying out of the unused inkjets, ink droplets may be ejected from the unused inkjets onto an absorbent member 178 of the retractable printhead shield 170.

More specifically, while the print job is being completed according to step 240, the method 200 can include, in a step 250, determining a plurality of unused inkjets corresponding to the unused portion(s) 158 of the one or more printheads 154A-D. The controller 107 of the printing system 100 will have information regarding the geometry and layout of the individual printheads and can determine, based on the print job attributes (e.g., print media width, etc.), whether an inkjet is going to be used or not.

Then, while the print job is still being completed according to step 240, the method 200 can include, in a step 260, jetting/ejecting one or more ink droplets from the plurality of unused inkjets onto the absorbent layer 178 of the retractable printhead shield 170. As discussed above, the absorbent layer 178 can be configured to absorb at least a predetermined amount of accumulated ink, after which point, the absorbent layer 178 may be removed and replaced before continuing the print job or starting a new print job. This process may be repeated as many times as desired.

In particular embodiments, the frequency of jetting non-imaging ink droplets from the plurality of unused inkjets onto the absorbent layer 178 of the retractable printhead shield 170 may be controlled to maintain a desired micro-environment (around the unused inkjets) in order to prevent drying out. In some embodiments, the frequency may be from about 5 Hz to about 20 Hz. In further embodiments, the total number of non-imaging ink droplets jetted can be counted and recorded by the printer controller 107. Because the size of each non-imaging ink droplet is known, the total amount of ink accumulated on the printhead shield 170 and the absorbent layer 178 can be tracked and an alert may be provided to a user to recommend replacement of the absorbent layer 178.

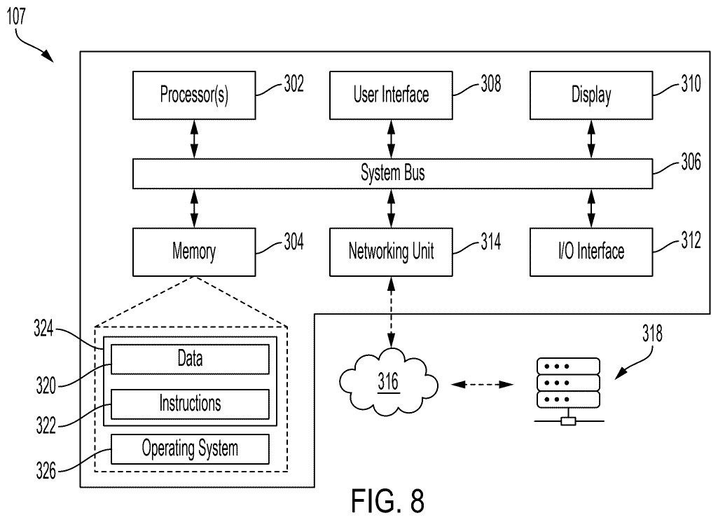

With reference to FIG. 8, the printer controller 107 of the printing system 100 can include one or more processors 302 and a computer-readable memory 304 interconnected and/or in communication via a system bus 306 containing conductive circuit pathways through which instructions (e.g., machine-readable signals) may travel to effectuate communication, tasks, storage, and the like. The printer controller 107 can be connected to a power source (not shown), which can include an internal power supply and/or an external power supply. In embodiments, the printer controller 107 can also include one or more additional components, such as a user interface 308, a display 310, an input/output (I/O) interface 312, a networking unit 314, and the like, including combinations thereof. As shown, each of these components may be interconnected and/or in communication via the system bus 306, for example.

In embodiments, the one or more processors 302 can include one or more high-speed data processors adequate to execute the program components described herein and/or perform one or more operations of the methods described herein, including but not limited to receiving print job instructions and data, converting the information into instructions for actuating individual inkjets of one or more printheads to form an image on a print media, and operating the one or more piezoelectric printheads to form said image. The one or more processors 302 may include a microprocessor, a multi-core processor, a multithreaded processor, an ultra-low voltage processor, an embedded processor, and/or the like, including combinations thereof. The one or more processors 302 can include multiple processor cores on a single die and/or may be a part of a system on a chip (SoC) in which the processor 302 and other components are formed into a single integrated circuit, or a single package. That is, the one or more processors 302 may be a single processor, multiple independent processors, or multiple processor cores on a single die.

In embodiments, the user interface 308 may be configured to receive various forms of input from a user associated with the printer controller 107. The user interface 308 can include, but is not limited to, one or more of a keyboard, keypad, trackpad, trackball(s), capacitive keyboard, controller (e.g., a gaming controller), computer mouse, computer stylus/pen, a voice input device, and/or the like, including combinations thereof.

In embodiments, the display device 310 may be configured to display information, including text, graphs, and/or the like. The display device 310 can include, but is not limited to, a liquid crystal display (LCD), a light-emitting diode (LED) display, a touch screen or other touch-enabled display, a foldable display, a projection display, and so on, or combinations thereof.

In embodiments, the input/output (I/O) interface 312 may be configured to connect and/or enable communication with one or more peripheral devices (not shown), including but not limited to additional machine-readable memory devices, diagnostic equipment, and other attachable devices. The I/O interface 312 may include one or more I/O ports that provide a physical connection to the one or more peripheral devices. In some embodiments, the I/O interface 212 may include one or more serial ports.

In embodiments, the networking unit 314 may include one or more types of networking interfaces that facilitate wired and/or wireless communication between the printer controller 107 and one or more external devices. That is, the networking unit 314 may operatively connect the printer controller 107 to one or more types of communications networks 316, which can include a direction interconnection, the Internet, a local area network (“LAN”), a metropolitan area network (“MAN”), a wide area network (“WAN”), a wired or Ethernet connection, a wireless connection, a cellular network, Bluetooth®, and similar types of communications networks, including combinations thereof. In some embodiments, the printer controller 107 may communicate with one or more remote/cloud-based servers and/or cloud-based services, such as remote server 318, via the communications network 316.

In embodiments, the memory 304 can be variously embodied in one or more forms of machine accessible and machine-readable memory. In some embodiments, the memory 304 can be a storage device, which can include, but is not limited to, a non-transitory storage medium, a magnetic disk storage, an optical disk storage, an array of storage devices, a solid-state memory device, and/or the like, as well as combinations thereof. The memory 304 may also include one or more other types of memory, such as dynamic random-access memory (DRAM), static random-access memory (SRAM), erasable programmable read-only memory (EPROM), electrically erasable programmable read-only memory (EEPROM), Flash memory, and/or the like, as well as combinations thereof. In embodiments, the memory 304 may include one or more types of transitory and/or non-transitory memory.

The printer controller 107 can be configured by software components stored in the memory 304 to perform one or more processes of the methods described herein. More specifically, the memory 304 can be configured to store data/information 320 and computer-readable instructions 322 that, when executed by the one or more processors 302, causes the printing system 100 to complete one or more print jobs in accordance with the method 200. Such data 320 and the computer-readable instructions 322 stored in the memory 304 may form an inkjet preservation package 224 that may be incorporated into, loaded from, loaded onto, or otherwise operatively available to and from the printer controller 107. Thus, in some embodiments, the inkjet preservation package 324 and/or one or more individual software packages may be stored in a local storage device of the memory 304. However, in other embodiments, the inkjet preservation package 324 and/or one or more individual software packages may be loaded onto and/or updated from a remote server or service, such as server 318, via the communications network 316.

The printer controller 107 may also include an operating system component 326, which may be stored in the memory 304. The operating system component 326 may be an executable program facilitating the operation of the printer controller 107. Typically, the operating system component 326 can facilitate access of the I/O interface 312, network interface 314, the user interface 308, and the display 310, and can communicate or control other components of the printing system 100.

Accordingly, also provided herein is a computer program product 324 comprising a non-transitory computer-readable storage medium 304 having stored thereon computer-readable instructions 322 that, when executed by one or more processors (such as processors 302), cause the one or more processors to perform one or more operations of the methods described below.

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein. It should also be appreciated that terminology explicitly employed herein that also may appear in any disclosure incorporated by reference should be accorded a meaning most consistent with the particular concepts disclosed herein.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.”

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified.

As used herein, although the terms first, second, third, etc. may be used herein to describe various elements or components, these elements or components should not be limited by these terms. These terms are only used to distinguish one element or component from another element or component. Thus, a first element or component discussed below could be termed a second element or component without departing from the teachings of the inventive concept.

Unless otherwise noted, when an element or component is said to be “connected to,” “coupled to,” or “adjacent to” another element or component, it will be understood that the element or component can be directly connected or coupled to the other element or component, or intervening elements or components may be present. That is, these and similar terms encompass cases where one or more intermediate elements or components may be employed to connect two elements or components. However, when an element or component is said to be “directly connected” to another element or component, this encompasses only cases where the two elements or components are connected to each other without any intermediate or intervening elements or components.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively.

It should also be understood that, unless clearly indicated to the contrary, in any methods claimed herein that include more than one step or act, the order of the steps or acts of the method is not necessarily limited to the order in which the steps or acts of the method are recited.

The above-described examples of the described subject matter can be implemented in any of numerous ways. For example, some aspects can be implemented using hardware, software or a combination thereof. When any aspect is implemented at least in part in software, the software code can be executed on any suitable processor or collection of processors, whether provided in a single device or computer or distributed among multiple devices/computers.

The present disclosure can be implemented as a system, a method, and/or a computer program product at any possible technical detail level of integration. The computer program product can include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium comprises the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network can comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure can be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, comprising an object oriented programming language such as Smalltalk, C++, or the like, and procedural programming languages, such as the “C” programming language or similar programming languages. The computer readable program instructions can execute entirely on the user's computer, partly on the user's computer, as a stand-alone software package, partly on the user's computer and partly on a remote computer or entirely on the remote computer or server. In the latter scenario, the remote computer can be connected to the user's computer through any type of network, comprising a local area network (LAN) or a wide area network (WAN), or the connection can be made to an external computer (for example, through the Internet using an Internet Service Provider). In some examples, electronic circuitry comprising, for example, programmable logic circuitry, field-programmable gate arrays (FPGA), or programmable logic arrays (PLA) can execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to examples of the disclosure. It will be understood that each block of the flowchart illustrations and/or block diagrams, and combinations of blocks in the flowchart illustrations and/or block diagrams, can be implemented by computer readable program instructions.

The computer readable program instructions can be provided to a processor of a, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions can also be stored in a computer readable storage medium that can direct a computer, a programmable data processing apparatus, and/or other devices to function in a particular manner, such that the computer readable storage medium having instructions stored therein comprises an article of manufacture comprising instructions which implement aspects of the function/act specified in the flowchart and/or block diagram or blocks.

The computer readable program instructions can also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various examples of the present disclosure. In this regard, each block in the flowchart or block diagrams can represent a module, segment, or portion of instructions, which comprises one or more executable instructions for implementing the specified logical function(s). In some alternative implementations, the functions noted in the blocks can occur out of the order noted in the Figures. For example, two blocks shown in succession can, in fact, be executed substantially concurrently, or the blocks can sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Other implementations are within the scope of the following claims and other claims to which the applicant can be entitled.

While several inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

What is claimed is:

1. An inkjet printing system comprising:
a media transport system configured to move a print media substrate through a printing zone of the printing system in a process direction;
a printhead mounting plate spaced vertically apart from the media transport system, wherein the printhead mounting plate comprises (i) a first surface, (ii) a second surface, and (iii) one or more frames configured to receive one or more printheads at the first surface, respectively, wherein the second surface is vertically adjacent to the media transport system;
a retractable printhead shield disposed between the second surface of the printhead mounting plate and the media transport system, wherein the retractable printhead shield has a width that is greater than or equal to a width of the one or more frames; and
a linear actuator coupled to the retractable printhead shield and configured to slide the retractable printhead shield under the one or more frames in a direction perpendicular to the process direction.

2. The inkjet printing system of claim 1, further comprising:
a controller operatively connected to the linear actuator, wherein the controller is configured to adjust a position of the retractable printhead shield, via the linear actuator, such that a portion of at least one frame of the one or more frames is covered.

3. The inkjet printing system of claim 2, wherein the position of the retractable printhead shield is adjusted based on a width of the print media substrate moving through the printing zone.

4. The inkjet printing system of claim 3, wherein the controller is configured to (i) determine an unused portion of the one or more printheads received by the one or more frames, and (ii) adjust the position of the retractable printhead shield to cover the unused portion of the one or more printheads.

5. The inkjet printing system of claim 1, wherein the retractable printhead shield comprises a first absorbent layer disposed on a frame-facing surface of the retractable printhead shield, the first absorbent layer being configured to absorb an amount of ink ejected by the one or more printheads.

6. The inkjet printing system of claim 5, wherein the first absorbent layer is configured to be replaceable by at least a second absorbent layer.

7. The inkjet printing system of claim 1, wherein the retractable printhead shield and linear actuator are mounted onto the printhead mounted plate.

8. The inkjet printing system of claim 1, wherein the width of the retractable printhead shield is approximately equal to a width of the printhead mounting plate.

9. The inkjet printing system of claim 1, wherein the retractable printhead shield has a length that is greater than or equal to a length of the one or more frames.

10. The inkjet printing system of claim 1, wherein second surface of the printhead mounting plate is spaced less than 5 mm vertically apart from the media transport system, and wherein the retractable printhead shield is a thin planar sheet having a thickness of less than 1 mm.

11. A print bar assembly comprising:
a printhead mounting plate comprising (i) a first surface, (ii) a second surface, and (iii) one or more frames configured to receive one or more printheads at the first surface, respectively;
a retractable printhead shield disposed vertically adjacent to the second surface of the printhead mounting plate, wherein the retractable printhead shield has a width that is greater than or equal to a width of the one or more frames; and
a linear actuator coupled to the retractable printhead shield and configured to slide the retractable printhead shield under the one or more frames in a direction perpendicular to a process direction.

12. The print bar assembly of claim 11, wherein the retractable printhead shield comprises a first absorbent layer disposed on a frame-facing surface of the retractable printhead shield, the first absorbent layer being configured to absorb an amount of ink ejected by the one or more printheads.

13. The print bar assembly of claim 12, wherein the first absorbent layer is configured to be replaceable by at least a second absorbent layer.

14. The print bar assembly of claim 11, wherein the retractable printhead shield and linear actuator are mounted onto the printhead mounted plate.

15. The print bar assembly of claim 11, wherein the width of the retractable printhead shield is approximately equal to a width of the printhead mounting plate.

16. The print bar assembly of claim 11, wherein the retractable printhead shield has a length that is greater than or equal to a length of the one or more frames.

17. The print bar assembly of claim 11, wherein the retractable printhead shield is a thin planar sheet having a thickness of less than 1 mm.

18. A method for preserving inkjet health in an inkjet printing system, the method comprising:
receiving, by the inkjet printing system, a print job to be completed by the inkjet printing system, wherein the print job comprises print job attributes including at least a print media substrate width;
determining, by the inkjet printing system, an unused portion of one or more printheads of the inkjet printing system based on the print media substrate width;
adjusting, via a linear actuator of the inkjet printing system, a position of a retractable printhead shield such that the retractable printhead shield covers the unused portion of the one or more printheads.

19. The method of claim 18, further comprising:
rendering an image on the print media substrate based on the print job received.

20. The method of claim 19, further comprising:
determining, by the inkjet printing system, a plurality of unused inkjets corresponding to the unused portion of the one or more printheads; and
ejecting, by the inkjet printing system, one or more ink droplets from the plurality of unused inkjets onto an absorbent layer of the retractable printhead shield while rendering the image on the print media substrate.
